(19) United States
(12) Patent Application Publication
(10) Pub. No.: US 2026/0268027 A1
(43) Pub. Date: Sep. 10, 2026

(54) SECURE DISTRIBUTION OF DEVICE SECURITY CONFIGURATIONS

(71) Applicant: MICROSOFT TECHNOLOGY LICENSING, LLC, Redmond, WA (US)

(72) Inventor: Kunyan LIU, San Diego, CA (US)

(21) Appl. No.: 19/075,683

(22) Filed: Mar. 10, 2025

(51) Int. Cl. G06F 21/72; G06F 21/64

(52) U.S. Cl. CPC G06F 21/72; G06F 21/64

(57) ABSTRACT

Improved security techniques for multichip may include data masking and integrity verification for inter-chiplet communications. At a primary chiplet, a pseudo-random number may be generated and used as a cryptographic salt. The cryptographic salt may be used to mask security configuration information, and the salt may also be used to generate a signature of the masked configuration information. A security data package including the cryptographic salt, the masked configuration information, and the signature may be sent from the primary chiplet to a secondary chiplet over an inter-chiplet communication link. The secondary chiplet may then verify the integrity of the masked configuration information using the salt and the signature, and the configuration information can be unmasked based on the salt. If the integrity is verified, a security state of the secondary chipset may be adjusted based on the unmasked security configuration information.

### BACKGROUND

Integrated circuit (IC) devices generally include a chip of electronic circuits enclosed in a protective packaging. The chip material is typically a semiconductor such as silicon while the packaging is generally an electrically insulating material such as plastic resin or ceramic. The circuits in the chip are connected to other devices by wires from the chip to electrical contacts on the exterior of the device packaging material. Complex IC devices may include more than one chip (or “chiplet”) within a single protective package. Communication between chiplets within a single IC package may be facilitated by wires between the chiplets that are not generally accessible outside the packaging of the IC device.

Computer processors are often IC devices that include adjustable security states which enable or disable various security functions of a processor. For example, some security states may restrict operation of the processor in order to preserve the privacy of any user data in the processor, while other less restrictive security states may enable debugging or manufacturing validation functions that allow an inspection and/or control of the processor. A processor’s security state may be based on a lifecycle state of the processor, for example, where a less restricted security state is enabled for hardware quality verification during a “manufacturing” lifecycle stage, while more restrictive security states may be used after manufacturing during a “production” lifecycle stage. For a processor implemented as a multichip package device, adjusting the security state may require distributing security configuration information between chiplets within the device such that security states of the individual chiplets may be adjusted to correspond to a desired overall security state for the multichip device.

### SUMMARY

Improved integrated circuits include techniques for securing communication of security configuration information between chiplets inside a multichip device package. In order to adjust a security state of a multichip device, the desired security configuration may need to be communicated between chiplets, such as where different chiplets implement different aspects of the desired security state. Communication between chiplets may be more vulnerable to detection or manipulation by nefarious entities as compared to communications within a single chip, and hence, enhanced communication security between chiplets is desired.

Improved multichip security techniques may include data masking and integrity verification of inter-chiplet communications. A primary chiplet may be a source of security configuration information. Within the primary chiplet, a random number generator may generate a pseudo-random number to be used as a cryptographic salt. Then the cryptographic salt number may be used to encrypt the security configuration information and generate masked configuration information. The same salt may also be used to generate a signature of the masked configuration information. A security data package including the cryptographic salt, the masked configuration information, and the signature may be sent from the primary chiplet to a secondary chiplet over an inter-chiplet communication link. The secondary chiplet may then verify the integrity of the masked configuration information using the salt and the signature, and the configuration information can be unmasked based on the salt. If the integrity is verified, a security state of the secondary chipset may be adjusted based on the unmasked security configuration information.

In some aspects, the primary chiplet may determine security configuration information based on a lifecycle state of the multichip device. In other aspects, when the secondary chiplet cannot verify the integrity of a security data package, the secondary chiplet may be adjusted to a most-secure or most-restrictive security state and/or the primary chiplet may be notified of a failed integrity check.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 depicts an example multichip integrated circuit device.

FIG. 2 depicts an example security data package.

FIG. 3 depicts an example method at a primary chiplet for securely sending a data package.

FIG. 4 depicts an example method at a secondary chiplet for securely receiving a data package.

FIG. 5 depicts a block diagram of a computing-based device that may be included in any of the above systems and may be used to implement any of the above methods.

### DETAILED DESCRIPTION

Improved designs for integrated circuits include techniques for securing communication of security configuration information between chiplets inside a multichip device package. Complex devices such as a system-on-a-chip (SoC) or a computer processor generally include an adjustable security state. For example, a first processor security state that enables highly invasive testing or validation may be used during manufacturing of the device and may represent a highly compromised (low) level of security. After manufacturing, a second processor security state may enable hardware or software debugging that allows for inspection and manipulation of a subset of control registers and data stores withing the device and may represent a moderate level of security. A third processor security state may disable most or all outputs from the processor as a highest level of security and may be used, for example, at boot time of the device until a root-of-trust inside the processor determines the processor is in a safe environment and selects a security configuration with a lower level of security. Any process for changing between such security states should itself be a secure and reliable process. Furthermore, a lower complexity process for changing security states is particularly desirable since the process for changing between security states should work reliably and simply in order to verify a device design and to test individual devices as they are manufactured.

Multichip devices may require communication of a desired security configuration between chiplets where each chiplet may implement different aspects of the whole device’s security state. Communication between chiplets may occur over wires and hence may be more vulnerable to detection or manipulation by nefarious entities than communications over a silicon trace within a single chip. For example, by recording traces of power consumption of a multichip package, an attacker may be able to detect inter-chiplet communications, and exposure to pulses of electromagnetic (EM) radiation or carefully controlled power supply interruptions may allow for manipulation of inter-chiplet communication. Hence, a need is perceived for improved inter-chiplet communication techniques that may mitigate such attacks.

Improved security techniques for multichip devices may include masking and integrity verification of inter-chiplet communications. A primary chiplet may be a source of security configuration information. Within the primary chiplet, a random number generator may generate a pseudo-random number to be used as a cryptographic salt. Then the cryptographic salt may be used to encrypt the security configuration information to generate masked configuration information, and the salt may also be used to generate a signature of the masked configuration information. A security data package including the salt, the masked configuration information, and the signature may be sent from the primary chiplet to a secondary chiplet over an inter-chiplet communication link. The secondary chiplet may then verify the integrity of the masked configuration information using the salt and the signature, and the configuration information can be unmasked based on the salt. If the integrity is verified, a security state of the secondary chipset may be adjusted based on the unmasked security configuration information.

In some aspects, the primary chiplet may determine the security configuration information to be sent to a secondary chiplet. In one example, the primary chiplet may determine security configuration information based on a lifecycle state of the multichip device. A security configuration corresponding to a lower level of security may be selected when the device is still in a “manufacturing” lifecycle stage, a security configuration corresponding to a middle level of security may be selected for a “debugging” lifecycle stage, and a security configuration corresponding to a higher security state may be selected for a “production” lifecycle stage. In some implementations, security configuration information may be based on the state of physical fuses in the device that can be set or adjusted during and/or after manufacturing of the device, and such fuses may adjusted at transitions between stages of the device’s lifecycle.

In other aspects, a security processor in the primary chiplet may serve as a root-of-trust for the whole multi-chip device. The security processor may be able to determine if the device is operating in a secure environment, such as by verifying digitally signed certificates received from externally connected devices such as memory controller or a baseboard management controller (BMC). At every boot time, a primary chiplet may first configure the device in a highly secure state, and then later, after determining the device is operating in a secure environment, the primary chiplet may reduce the device’s security by selecting security configuration data and sending the selected security configuration data to the secondary chiplet using the secure communication techniques described herein, such as with data masking for privacy and with cryptographic signatures to verify data integrity.

In an aspect, when the secondary chiplet cannot verify the integrity of a received security data package, the secondary chiplet may adjust its security state to a higher, most-secure, or most-restrictive security state. Alternately or in addition, the secondary chiplet may attempt to notify the primary chiplet when the integrity of the received security data package cannot be verified.

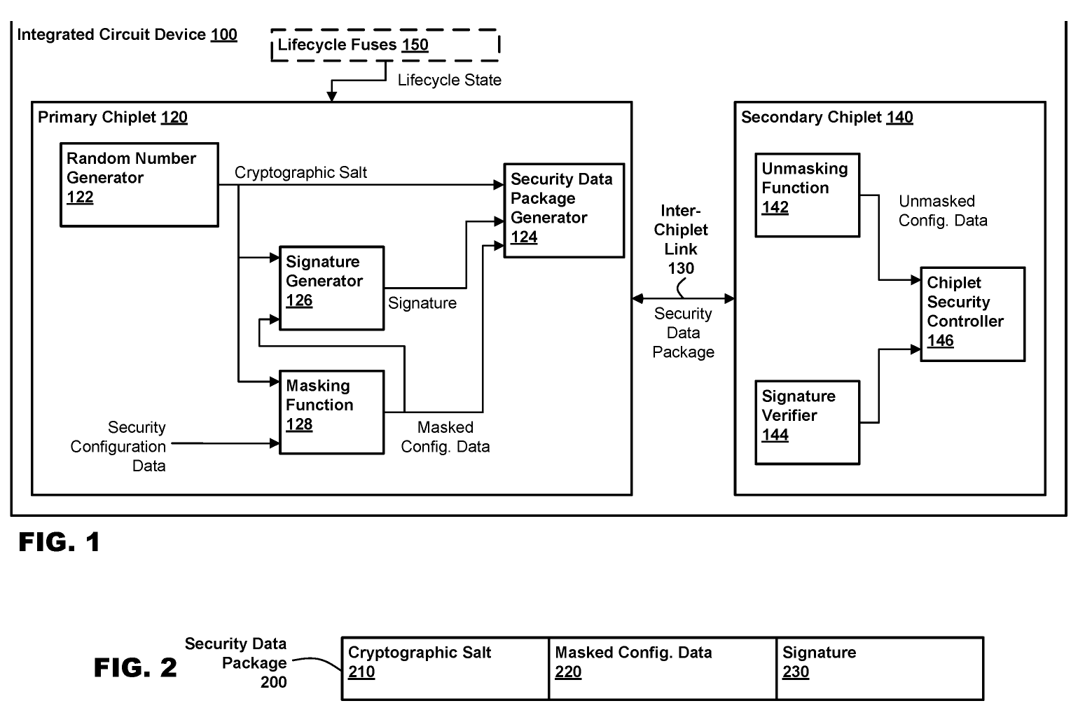

FIG. 1 depicts an example multichip integrated circuit (IC) device 100. IC device 100 includes a primary chiplet 120, a secondary chiplet 140, and inter-chiplet communication link 130 and optional lifecycle stage fuses 150. IC device 100 may be, for example, a multichip package implementing a computer processor or a complete system-on-a-chip (SoC) device. Primary and secondary chiplets 120, 140 may include electrical circuits embedded in a semiconductor chip, and both chiplets may be embedded in a single protective packaging such as plastic resin or ceramic. Inter-chiplet communication link 130 may include, for example, one or more wires internal to the packing of the IC device 100 providing a serial or parallel data bus using an I2C protocol. In the example of FIG. 1, chiplet 120 is “primary” in that it may serve as a source of security configuration data, and chiplet 140 is “secondary” in that it may receive security configuration data when a security state of IC device 100 is adjusted.

Primary chiplet 120 includes random number generator 122, security data package generator 124, signature generator 126, and a masking function 128. In an aspect, one or more of random number generator 122, security data package generator 124, signature generator 126, and a masking function 128 may be implemented as part of a security processor (not depicted), and a security processor in primary chiplet 120 may serve as a root-of-trust for the whole IC device 100. Primary chiplet 120 may serve as a source of security configuration data for secondary chiplet 140 and the security configuration data may be based, for example, on a lifecycle state of IC 100 (e.g., a manufacturing stage, a debugging stage, or normal runtime life stage), an environment in which IC 100 operates (e.g., what devices are attached to IC device 100 and can then be authenticated). In an aspect, primary chiplet 120 may determine a current lifecycle state of IC device 100 at least in part based on optional lifecycle stage fuses 150.

In operation, primary chiplet 120 may generate security configuration data, for example based on lifecycle and environment factors. Random number generator 122 may produce a pseudo-random number to be used as a cryptographic salt in subsequent operations. Masking function 128 may encrypt the cleartext security configuration data based on the cryptographic salt to produce masked version of the configuration data. In one example, masking function 128 may simply XOR the security configuration data with the same cryptographic salt used by signature generator 126. Signature generator 126 may generate a digital signature, for example by applying a hash function based on the cryptographic salt to the masked configuration data. In one example, a lightweight (lower complexity) hash function such as a 25-bit Keccak hash may be used. In an alternate embodiment (not depicted), signature generator may generate a signature of cleartext security configuration data prior to masking it. Security data package 124 generator may collect the cryptographic salt, the signature, and the masked configuration data into a single security data package (such as depicted in FIG. 2) to be sent to secondary chiplet 140 via inter-chiplet communication link 130.

Secondary chiplet 140 includes unmasking function 142, chiplet security controller 146, and signature verifier 144. In operation, secondary chiplet 140 may receive a security data package including a cryptographic salt, masked configuration data, and a digital signature (such as depicted in FIG. 2) from primary chiplet 120 via inter-chiplet link 130. Unmasking function 142 may decrypt the masked configuration data based on the cryptographic salt, for example using an XOR function. Signature verifier 144 may verify the security data package’s signature, for example by first generating a new signature based on the masked configuration data and the salt, and then comparing the newly generated signature to the signature received in the signature included in the security data package. When the signatures are identical, the integrity of the received security data package has been verified. When the signatures are not the same, the integrity of the received security data package is not verified, which may suggest the integrity of the package was compromised during transmission over inter-chiplet link 130. When integrity of the received data package is verified, chiplet security controller 146 may adjust a security state of secondary chiplet 140 based on the unmasked configuration data. In an aspect, the security state of the secondary chiplet may be a subset of the security state of the entire IC device 100.

In an alternate embodiment, if signature generator 126 generates a signature based on cleartext configuration data, signature verifier 144 may also generate the new signature based on unmasked configuration data instead of using the masked configuration data.

FIG. 1 depicts just one secondary chiplet 140. However, embodiments of this disclosure are not so limited. Other implementations (not depicted) may include more than one secondary chiplet. In such implementations, a primary chiplet may send security configuration data to multiple secondary chiplet using the secure communication techniques described herein. In some cases, the same security configuration data may be sent to multiple secondary chiplets, and in other cases, different security configuration data may be sent to different secondary chiplets. For example, the different security data packages sent to each secondary chiplet may correspond to the different subsets of IC device 100’s security state that is implemented by each secondary chiplet. By sending only a subset of configuration information of the whole device’s security state to each chiplet, the size of each security data package may be smaller (requiring fewer bits) and may reduce the complexity (and increase reliability) of masking/unmasking and signature verification.

FIG. 2 depicts an example security data package 200 which illustrates an example data format generated by security data package generator 124 (FIG. 1). Security data package 200 includes a cryptographic salt 210, masked configuration data 220, and signature 230. In one aspect, a length of the cryptographic salt 210 and a length of the masked configuration data 220 may be identical, such as 64 bits. In another aspect, signature 230 may be digital signature shorter than the length of the masked configuration data, such as 25 bits.

In one aspect, signature 230 may be a signature (based on cryptographic salt 210) of only the masked configuration data 220. In another aspect, signature 230 may be a signature (based on cryptographic salt 210) of both cryptographic salt 210 and masked configuration data 220. For example, a 64-bit cryptographic salt 210 may be concatenated to a 64-bit masked configuration data 220 to produce a 128-bit data block, and then the 128-bit data block may be signed using the 64-bit cryptographic salt and a 25-bit Keccak hash function to produce a 25 bit signature 230.

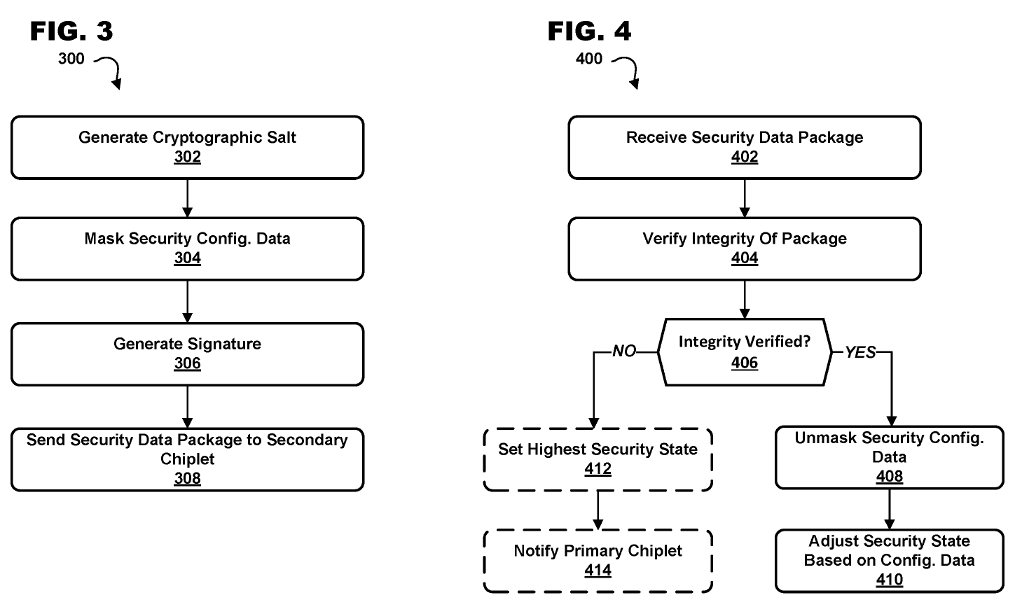

FIG. 3 depicts an example method 300 at a primary chiplet for securely sending a data package. Method 300 may be performed, for example, by primary chiplet 120 (FIG. 1). Method 300 includes generating a cryptographic salt (box 302), masking security configuration data (box 304) based on the cryptographic salt, generating a signature (box 306) of security configuration data, and sending a security data package (box 308) from a primary chiplet to a secondary chiplet.

FIG. 4 depicts an example method 400 at a secondary chiplet for securely receiving a data package. Method 400 may be performed, for example, by secondary chiplet 140 (FIG. 1). Method 400 includes receiving a security data package from a primary chiplet (box 402) which may include a cryptographic salt number, masked security configuration data, and a digital signature. The integrity of the received data package (box 404) may be verified, such as by generating a new signature and comparing it to the signature received in the security data package. When the integrity is verified (box 406), masked security configuration data may be unmasked (box 408), and a security state of the secondary chiplet may be adjusted based on the unmasked configuration data (box 410).

In various aspects, the signature generated (box 306) may be generated from either masked or cleartext configuration data as long as the same version of configuration data is used to create the original signature in the primary chiplet (e.g., box 306) and the new signature in the secondary chiplet (e.g., box 404).

In an optional aspect, when the integrity of the security data package is not verified (box 406), then a security state of the secondary chiplet may revert its current security state to a higher or even highest possible security state (box 412), and/or the secondary chiplet may attempt to notify the primary chiplet of the failed integrity verification (box 414), such as by sending a interrupt from the secondary chiplet to the primary chiplet via inter-chiplet communication link 130 (FIG. 1).

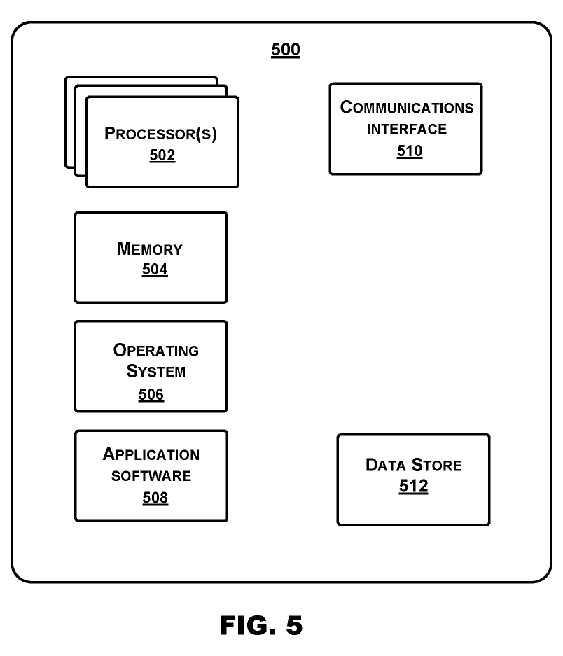

FIG. 5 depicts a block diagram of a computing-based device 500 that may be included in any of the above systems and may be used to implement any of the above methods. FIG. 5 illustrates various components of an example computing-based device 500 which are implemented as any form of a computing and/or electronic device. In some examples, computing-based device 500 is a general-purpose computer that is activated or reconfigured by a computer program stored in the computer. In other examples, computing-based device 500 is specially constructed for the intended purpose. In some examples, computing device 500 is a microprocessor used in embedded systems applications or other suitable applications. Processor(s) 502 may be employed as examples of (or an example component of) integrated circuit device 100, primary chiplet 120, and secondary chiplet 140 (FIG. 1) and device 500 may be used to implement some or all of methods 300 and 400 (FIGS. 3 and 4).

Computing-based device 500 comprises one or more processors 502 which are microprocessors, controllers, or any other suitable type of processors for processing computer executable instructions to control the operation of the device. The processor(s) 502 may include at least one general-purpose processing device such as a central processing unit, microprocessor, complex instruction set computing (CISC) microprocessor, reduced instruction set computing (RISC) microprocessor, or other general-purpose processing device. In some examples, for example where a system on a chip architecture is used, the processors 502 include one or more special-purpose processing device such as a fixed function block. The special-purpose processing device may be configured to execute instructions for performing the operations and methods described herein. Platform software comprising an operating system 506 or any other suitable platform software is provided at the computing-based device to enable application software 508 to be executed on the device. Data store 512 holds system prompts, context, bot code and other data.

The computer executable instructions are provided using any computer-readable media that is accessible by computing-based device 500. Computer-readable media includes, for example, computer storage media such as memory 504 and communications media. Computer storage media, such as memory 504, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device.

In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 504) is shown within the computing-based device 500 it will be appreciated that the storage is, in some examples, distributed or located remotely and accessed via a network or other communication link (e.g., using communication interface 510). The computing-based device is able to communicate with other bots and communications network nodes via communications interface 510.

The disclosure presented herein also encompasses the subject matter set forth in the following clauses:

Example Clause 1: A method for securely distributing security configuration data between a primary chiplet to a secondary chiplet within an integrated circuit device package, comprising:

generating, by a pseudorandom number generator in the primary chiplet, a cryptographic salt;

masking, by a masking function of the primary chiplet, the security configuration data for the secondary chiplet based on the cryptographic salt to generate masked configuration data;

generating a signature of the masked configuration data based on the cryptographic salt;

sending, to the secondary chiplet, a security data package including the cryptographic salt, the masked configuration data, and the signature.

Example Clause 2: The method of clause 1, further comprising:

receiving, at the secondary chiplet, the security data package;

verifying an integrity of the masked configuration data based on the cryptographic salt, the masked configuration data, and the signature;

unmasking the masked configuration data to generate unmasked security configuration data;

when the integrity is verified, adjusting a security state of the secondary chiplet based on the unmasked security configuration data.

Example clause 3: The method of clauses 1-2, further comprising:

when the integrity is not verified, sending an interrupt, from the secondary chiplet to the primary chiplet, indicating that the integrity of the unmasked security configuration data was not verified.

Example clause 4: The method of clauses 1-3, wherein the masking includes XOR-ing of the cryptographic salt over a length of the security configuration data to produce the masked configuration data.

Example clause 5: The method of clauses 1-4, wherein the signature is output of a hash function based on the cryptographic salt when applied to a concatenation of the cryptographic salt and the masked configuration data.

Example clause 6: The method of clauses 1-5, wherein the security configuration data is based on lifecycle state fuses in the integrated circuit device package.

Example clause 7: The method of clauses 1-6, wherein the security configuration data indicates whether a debugging output from the secondary chiplet should be enabled.

Example clause 8: The method of clauses 1-7, wherein a length of the cryptographic salt in bits is the same as the length of the security configuration data.

Example clause 9: A system for securely distributing security configuration data within an integrated circuit device package, the system comprising:

a system-on-a-chip (SoC) including a primary chiplet and a secondary chiplet packaged together within the integrated circuit device package, the primary chiplet having a random number generator, a data masking function, and a signature generator, and the secondary chiplet having an adjustable security state, a signature verification function, and a data unmasking function;

wherein the primary chiplet is configured to:

generate, by the pseudorandom number generator, a cryptographic salt;

mask, by the data masking function, the security configuration data based on the cryptographic salt to generate masked configuration data;

generate, by the signature generator, a signature of the masked configuration data based on the cryptographic salt; and

send, to the secondary chiplet, a security data package including the cryptographic salt, the masked configuration data, and the signature.

Example clause 10: The system of clause 9, wherein the secondary chiplet is configured to:

receive the security data package from the primary chiplet;

verify an integrity of the masked configuration data based on the cryptographic salt, the masked configuration data, and the signature;

unmask the masked configuration data to generate unmasked security configuration data; and

when the integrity is verified, adjust a security state of the secondary chiplet based on the unmasked security configuration data.

Example clause 11: The system of clauses 9-10, wherein the secondary chiplet is further configured to:

when the integrity is not verified, send an interrupt, from the secondary chiplet to the primary chiplet, indicating that integrity of the unmasked security configuration data was not verified.

Example clause 12: The system of clauses 9-11, wherein the masking function includes XOR-ing of the cryptographic salt over a length of the security configuration data to produce the masked configuration data.

Example clause 13: The system of clauses 9-12, wherein the signature is output of a hash function based on the cryptographic salt when applied to a concatenation of the cryptographic salt and the masked configuration data.

Example clause 14: The system of clauses 9-13, wherein the security configuration data is based on lifecycle state fuses in the integrated circuit device package.

Example clause 15: The system of clauses 9-14, wherein the security configuration data indicates whether a debugging output from the secondary chiplet should be enabled.

Example clause 16: The system of clauses 9-15, wherein a length of the cryptographic salt in bits is the same as the length of the security configuration data.

Example clause 17: A non-transitory computer-readable storage medium storing instructions for securely distributing security configuration data between a primary chiplet to a secondary chiplet within an integrated circuit device package, the instructions, when executed on one or more processors, cause the one or more processors to:

generate, by a pseudorandom number generator in the primary chiplet, a cryptographic salt;

mask, by a masking function of the primary chiplet, the security configuration data for the secondary chiplet based on the cryptographic salt to generate masked configuration data;

generate a signature of the masked configuration data based on the cryptographic salt;

send, to the secondary chiplet, a security data package including the cryptographic salt, the masked configuration data, and the signature.

Example clause 18: The non-transitory computer-readable storage medium of clause 17, wherein the instructions further cause the one or more processors to:

receive, at the secondary chiplet, the security data package;

verify an integrity of the masked configuration data based on the cryptographic salt, the masked configuration data, and the signature;

unmask the masked configuration data to generate unmasked security configuration data; and

when the integrity is verified, adjust a security state of the secondary chiplet based on the unmasked security configuration data;

Example clause 19: The non-transitory computer-readable storage medium of clauses 17-18, wherein the instructions further cause the one or more processors to:

when the integrity is not verified, send an interrupt, from the secondary chiplet to the primary chiplet, indicating that integrity of the unmasked security configuration data was not verified.

Example clause 20: The non-transitory computer-readable storage medium of clause 17-19, wherein the masking function includes XOR-ing of the cryptographic salt over a length of the security configuration data to produce the masked configuration data.

In the above detailed description, reference is made to the accompanied drawings, which form a part hereof, and which is shown by way of illustration, specific example configurations of which the concepts can be practiced. These configurations are described in sufficient detail to enable those skilled in the art to practice the techniques disclosed herein, and it is to be understood that other configurations can be utilized, and other changes may be made, without departing from the spirit or scope of the presented concepts. The above detailed description is, therefore, not to be taken in a limiting sense, and the scope of the presented concepts is defined only by the appended claims.

The above description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms "based on" and "based upon" is not exclusive, and is equivalent to the term "based, at least in part, on," and includes the option of being based on additional factors, some of which may not be described herein. As another example, the term "via" is not exclusive, and is equivalent to the term "via, at least in part," and includes the option of being via additional factors, some of which may not be described herein. The phrase "in one example," as used herein does not necessarily refer to the same embodiment or example, although it may. Use of particular textual numeric designators does not imply the existence of lesser-valued numerical designators. References in the singular are made merely for clarity of reading and include plural references unless plural references are specifically excluded. The term "or" is an inclusive "or" operator unless specifically indicated otherwise. For example, the phrase "A or B" means "A, B, or A and B." As used herein, the terms "component" and "system" are intended to encompass hardware, software, or various combinations of hardware and software. Thus, for example, a system or component may be a process, a process executing on a computing device, the computing device, or a portion thereof. The meaning of “a,” “an,” and “the” includes plural reference, and the meaning of “in” includes “in” and “on.” The term “connected” means a direct electrical connection between the items connected, without any intermediate devices. The term “coupled” means a direct electrical connection between the items connected, or an indirect connection through one or more passive or active intermediary devices and/or components. The term “signal” means at least a power, current, voltage, data, electric wave, magnetic wave, electromagnetic wave, or optical signal. Based upon context, the term “coupled” may refer to a wave or field coupling effect, which may relate to a corresponding optical field, magnetic field, electrical field, or a combined electromagnetic field.

It will be understood that the configurations and/or approaches described herein are examples, and that these specific embodiments or examples are not to be considered in a limiting sense, because numerous variations are possible. As such, various systems, circuits, and/or devices may be broken into additional functions or circuits, and/or combined with other functions or circuits as may be desirable in a specific implementation. Similarly, the specific routines, procedures or methods described herein may represent one or more of any number of processing strategies. As such, various acts illustrated and/or described may be performed in the sequence illustrated and/or described, in other sequences, in parallel, or omitted. Likewise, the order of the above-described processes or methods may be changed. The subject matter thus includes all novel and non-obvious combinations and sub-combinations of the methods, processes, circuits, devices, systems and configurations, and other features, functions and/or properties disclosed herein, as well as any and all equivalents thereof.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for securely distributing security configuration data between a primary chiplet and a secondary chiplet within an integrated circuit device package, comprising:
generating, by a pseudorandom number generator in the primary chiplet, a cryptographic salt;
masking, by a masking function of the primary chiplet, the security configuration data for the secondary chiplet based on the cryptographic salt to generate masked configuration data;
generating a signature of the masked configuration data based on the cryptographic salt; and
sending, to the secondary chiplet, a security data package including the cryptographic salt, the masked configuration data, and the signature.

2. The method of claim 1, further comprising:receiving, at the secondary chiplet, the security data package;verifying an integrity of the masked configuration data based on the cryptographic salt, the masked configuration data, and the signature;
unmasking the masked configuration data to generate unmasked security configuration data; and
when the integrity is verified, adjusting a security state of the secondary chiplet based on the unmasked security configuration data.

3. The method of claim 2, further comprising:
when the integrity is not verified, sending an interrupt, from the secondary chiplet to the primary chiplet, indicating that the integrity of the unmasked security configuration data was not verified.

4. The method of claim 1, wherein the masking includes XOR-ing of the cryptographic salt over a length of the security configuration data to produce the masked configuration data.

5. The method of claim 1, wherein the signature is output of a hash function based on the cryptographic salt when applied to a concatenation of the cryptographic salt and the masked configuration data.

6. The method claim 1, wherein the security configuration data is based on lifecycle state fuses in the integrated circuit device package.

7. The method of claim 1, wherein the security configuration data indicates whether a debugging output from the secondary chiplet should be enabled.

8. The method of claim 1, wherein a length of the cryptographic salt in bits is the same as the length of the security configuration data.

9. A system for securely distributing security configuration data within an integrated circuit device package, the system comprising:
a system-on-a-chip (SoC) including a primary chiplet and a secondary chiplet packaged together within the integrated circuit device package, the primary chiplet having a pseudorandom number generator, a data masking function, and a signature generator, and the secondary chiplet having an adjustable security state, a signature verification function, and a data unmasking function;
wherein the primary chiplet is configured to:
generate, by the pseudorandom number generator, a cryptographic salt;
mask, by the data masking function, the security configuration data based on the cryptographic salt to generate masked configuration data;
generate, by the signature generator, a signature of the masked configuration data based on the cryptographic salt; and
send, to the secondary chiplet, a security data package including the cryptographic salt, the masked configuration data, and the signature.

10. The system of claim 9, wherein the secondary chiplet is configured to:receive the security data package from the primary chiplet;
verify an integrity of the masked configuration data based on the cryptographic salt, the masked configuration data, and the signature;
unmask the masked configuration data to generate unmasked security configuration data;
and when the integrity is verified, adjust a security state of the secondary chiplet based on the unmasked security configuration data.

11. The system of claim 10, wherein the secondary chiplet is further configured to:when the integrity is not verified, send an interrupt, from the secondary chiplet to the primary chiplet, indicating that integrity of the unmasked security configuration data was not verified.

12. The system of claim 9, wherein the masking function includes XOR-ing of the cryptographic salt over a length of the security configuration data to produce the masked configuration data.

13. The system of claim 9, wherein the signature is output of a hash function based on the cryptographic salt when applied to a concatenation of the cryptographic salt and the masked configuration data.

14. The system of claim 9, wherein the security configuration data is based on lifecycle state fuses in the integrated circuit device package.

15. The system of claim 9, wherein the security configuration data indicates whether a debugging output from the secondary chiplet should be enabled.

16. The system of claim 9, wherein a length of the cryptographic salt in bits is the same as the length of the security configuration data.

17. A non-transitory computer-readable storage medium storing instructions for securely distributing security configuration data between a primary chiplet to a secondary chiplet within an integrated circuit device package, the instructions, when executed on one or more processors, cause the one or more processors to:
cause a pseudorandom number generator in the primary chiplet to generate a cryptographic salt;
cause a masking function of the primary chiplet to mask the security configuration data for the secondary chiplet based on the cryptographic salt to generate masked configuration data;
generate a signature of the masked configuration data based on the cryptographic salt; and
send, to the secondary chiplet, a security data package including the cryptographic salt, the masked configuration data, and the signature.

18. The non-transitory computer-readable storage medium of claim 17, wherein the instructions further cause the one or more processors to:
cause the secondary chiplet to receive the security data package;
verify an integrity of the masked configuration data based on the cryptographic salt, the masked configuration data, and the signature;
unmask the masked configuration data to generate unmasked security configuration data; and
when the integrity is verified, adjust a security state of the secondary chiplet based on the unmasked security configuration data.

19. The non-transitory computer-readable storage medium of claim 18, wherein the instructions further cause the one or more processors to:
when the integrity is not verified, send an interrupt, from the secondary chiplet to the primary chiplet, indicating that integrity of the unmasked security configuration data was not verified.

20. The non-transitory computer-readable storage medium of claim 17, wherein the masking function includes XOR-ing of the cryptographic salt over a length of the security configuration data to produce the masked configuration data.
